(19) United States
(12) Patent Application Publication
(10) Pub. No.: US 2010/0003487 A1
(43) Pub. Date: Jan. 7, 2010

(54) Reflective Insulation Products and Methods for Manufacturing the Same

(75) Inventor: William H. Crostic, JR., Simpsonville, SC (US)

Correspondence Address: DORITY & MANNING, P.A., POST OFFICE BOX 1449, GREENVILLE, SC, 29602-1449, US

(73) Assignee: GUARDIAN BUILDING PRODUCTS, Greer, SC (US)

(21) Appl. No.: 12/166,931

(22) Filed: Jul. 2, 2008

(51) Int. Cl. B32B 7/12; D03D 9/00; B32B 5/00; B32B 37/00

(52) U.S. Cl. 428/220; 428/354; 442/1; 156/60

(57) ABSTRACT

In accordance with one embodiment of the present disclosure, a reflective insulation product is provided. The product includes a first outer layer having reflective material, a second outer layer, and an inner layer. The inner layer includes polyurethane foam and adhesive, the inner layer being positioned between the first outer layer and second outer layer such that the first outer layer is adhered to a first side of the inner layer by adhesive and the second outer layer is adhered to a second side of the inner layer by adhesive.

### BACKGROUND

Radiation is the transfer of heat or energy from a hot surface to a cold surface through air or a vacuum. For example, radiant heat from the sun travels through space and strikes the roof of a building and exterior walls of a building, causing the roof and exterior walls of the building to increase in temperature. Heat flows from the outer surface of the roof and exterior walls of the building to inner surfaces of the roof and the walls of the building through conduction. If the inner surfaces of the roof and walls of the building are warmer than surfaces inside the building that are spaced apart from the roof and inner walls of the building, heat will radiate from the inner surfaces of the roof and the walls of the building to the surfaces inside the building. Radiation between surfaces inside a building occurs through invisible infrared heat rays.

Heat can also exit a building through radiation. In winter months, surfaces inside a building are often warmer than the inner surfaces of the walls and the roof of the building. Warmer surfaces inside the building radiate heat to the inner surfaces of the walls and the roof of the building, causing them to increase in temperature. This heat flows from the inner surfaces of the walls and the roof of the building to the outer surface of the walls and roof of the building through conduction.

The ability of a material to emit radiant energy and absorb radiant energy is defined by the materials emissivity and reflectivity. The lower the emissivity of a material, the lower the amount of heat that is radiated from its surface. The higher the reflectivity of the material, the higher the percentage of incident radiant heat that is reflected from the material's surface. Radiant barriers and reflective insulation systems reduce radiant heat transfer between surfaces across open spaces, which is a significant contributor to heat gain during warm months and heat loss during cold months. Radiant barriers are a single layer of reflective material spaced apart from a surface which radiates heat. Radiant barriers do not prevent heat on one side of the reflected material from being conducted to the second side of the reflective material. Reflective insulation systems are typically laminate products that reduce heat transferred due to radiation, as well as convection. Reflective insulation systems typically include a reflective layer and a conduction preventing layer. The conduction preventing layer prevents heat on the reflective layer of the reflective insulation system from being conducted to the second side of the reflective insulation system.

Reflective insulation systems are installed such that a reflective layer is spaced apart from the roof decking or the outer wall of a building. Heat that is radiated inward from the roof or outer walls of the building is reflected off the reflective layer of the reflective insulation system back to the roof or outer surface of the building. The temperature of the roof or outer surface of the building increases rather than the interior of the building.

In winter applications, heat radiated by surfaces in the interior of the building are reflected back into the interior of the building if a reflective layer is included that faces the interior of the building. By reflecting radiant heat from the roof and external walls of the building back to the roof and outer walls of the building the heat that enters the building is reduced during warm months. By reflecting the heat radiated by the interior surfaces of the building back to the interior surfaces of the building, the heat that escapes from the building is reduced during cold months.

Numerous reflective insulation products are currently available. However, a need continues to exist for methods of forming reflective insulation products that are efficient and cost-effective. Reflective insulation products formed by utilizing such methods would be particularly beneficial.

### SUMMARY

Objects and advantages of the invention will be set forth in part in the following description, or may be obvious from the description, or may be learned through practice of the invention.

In accordance with one embodiment of the present disclosure, a reflective insulation product is provided. The product includes a first outer layer having reflective material, a second outer layer, and an inner layer. The inner layer includes polyurethane foam and adhesive, the inner layer being positioned between the first outer layer and second outer layer such that the first outer layer is adhered to a first side of the inner layer by adhesive and the second outer layer is adhered to a second side of the inner layer by adhesive.

In yet another embodiment of the present disclosure, a reflective insulation product is provided. The product includes a first outer layer having reflective material, a second outer layer, and an inner layer. The inner layer includes polyurethane foam and adhesive, the inner layer being positioned between the first outer layer and second outer layer such that the first outer layer is adhered to a first side of the inner layer by adhesive and the second outer layer is adhered to a second side of the inner layer by adhesive. The first outer layer, second outer layer, and inner layer have a combined thickness of from about 0.15 to about 0.30 inches.

In still another embodiment of the present disclosure, a method of making a reflective insulation product is described. The method includes unrolling a length of polyurethane foam insulation, applying adhesive on the polyurethane foam insulation, a first outer layer, a second outer layer, or combinations thereof, contacting the length of polyurethane foam insulation with a first outer layer, the first outer layer having reflective material, contacting the length of polyurethane foam insulation with the second outer layer, compressing the polyurethane foam insulation between the first outer layer and second outer layer, the polyurethane foam insulation being positioned between the first outer layer and second outer layer to form an inner layer, and allowing the first outer layer to adhere to a first side of the inner layer by the adhesive and the second outer layer to adhere to a second side of the inner layer by the adhesive.

Other features and aspects of the present disclosure are discussed in greater detail below.

### BRIEF DESCRIPTION OF THE DRAWINGS

A full and enabling disclosure, including the best mode thereof, directed to one of ordinary skill in the art, is set forth more particularly in the remainder of the specification, which makes reference to the appended figure in which:

FIG. 1A is a perspective view of a reflective insulation product in accordance with certain embodiments of the present disclosure;

FIG. 1B is a exploded perspective view of a reflective insulation product in accordance with certain embodiments of the present disclosure; and

FIG. 2 is a schematic view of a system that can be used in accordance with certain embodiments of the present disclosure.

Repeat use of reference characters in the present specification and drawings is intended to represent same or analogous features or elements of the disclosure.

### DETAILED DESCRIPTION

Reference now will be made in detail to various embodiments of the disclosure, one or more examples of which are set forth below. Each example is provided by way of explanation of the disclosure, not limitation of the disclosure. In fact, it will be apparent to those skilled in the art that various modifications and variations can be made in the present disclosure without departing from the scope or spirit of the disclosure. For instance, features illustrated or described as part of one embodiment, can be used on another embodiment to yield a still further embodiment. Thus, it is intended that the present disclosure covers such modifications and variations as come within the scope of the appended claims and their equivalents.

The present disclosure is generally directed to methods for making reflective insulation products. The methods described herein greatly simplify the process for making such products. In addition, the present disclosure describes a reflective insulation product having advantages over conventional products.

The present disclosure describes a reflective insulation product having a polyurethane foam inner layer. The reflective insulation product of the present disclosure provides improved performance and better resilience while eliminating certain health effects and environmental considerations of conventional products.

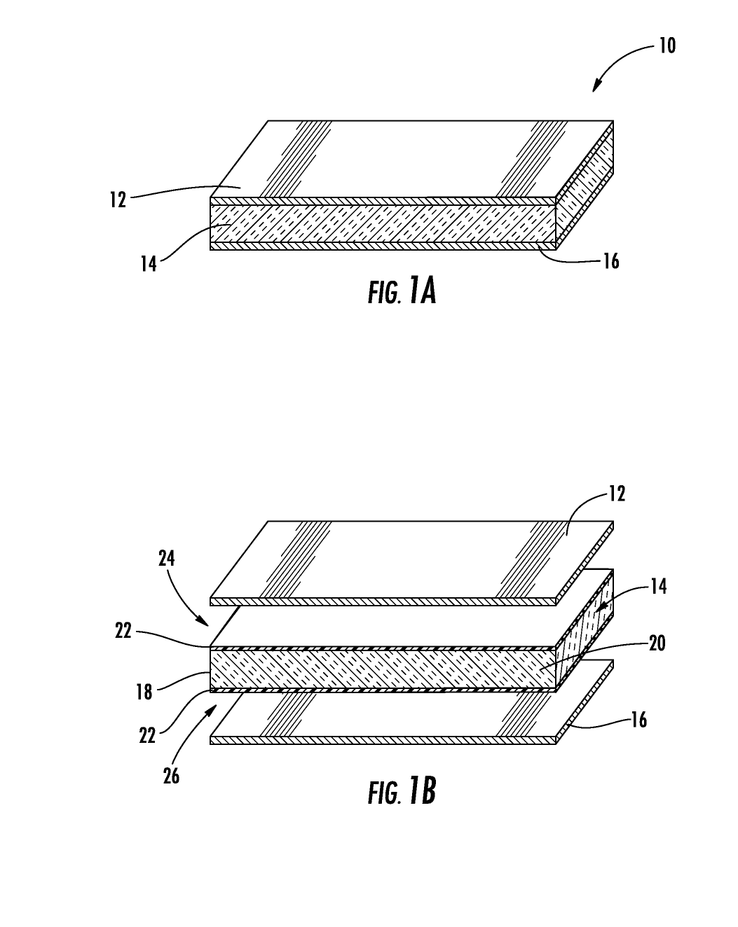

Referring to FIGS. 1A and 1B, a reflective insulation product 10 in accordance with certain embodiments of the present disclosure is illustrated. The reflective insulation product 10 includes a first outer layer 12, an inner layer 14, and a second outer layer 16.

The first outer layer 12 can be made from any suitable reflective material. An example of a suitable reflective material is aluminum. The first outer layer 12 can include an exterior layer that is made from reflective material. For example, the first outer layer 12 can be a laminate that includes an exterior layer made from a reflective material.

In certain embodiments, the first outer layer 12 is a laminate that includes a layer of aluminum foil adhered to a film by an adhesive. The film can be selected from suitable materials as would be known in the art such as polyester film and the adhesive can be any suitable adhesive, such as a flame resistant adhesive. The aluminum foil of the laminate can be from about 0.0001 to about 0.0005 inches thick and the film can be from about 0.00030 to about 0.00050 inches thick. When utilized, polyester film can strengthen the first outer layer 12, preventing it from being torn easily. Further, when the adhesive used to adhere the laminate together is flame resistant, the first outer layer 12 is resistant to flame spread and smoke development when the material is burned. An example of an acceptable first outer layer 12 is Cleveland Laminating's 8910 foil/polyester facing.

The second outer layer 16 can be formed from any suitable material. In certain embodiments, the second outer layer 16 is made from a vapor retarding material. In certain embodiments, the second outer layer 16 includes an exterior surface that is made from a suitable reflective material, such as aluminum. For example the second outer layer 16 can be a laminate that includes a layer of aluminum foil, a layer of scrim material, and a layer of kraft material. The layer of scrim can be a tri-directional fiberglass that reinforces the second outer layer 16. The kraft material can be bonded to the scrim material and the foil by an adhesive, such as a flame resistant adhesive. An example of an acceptable second outer layer 16 is Lamtec Corporation's R-3035 material.

In certain embodiments, the second outer layer 16 includes an outer plastic surface such as polypropylene. The second outer layer 16 can be a laminate that includes a polypropylene layer, a scrim material layer, and a kraft material layer. The polypropylene layer can be bonded to the reinforcing scrim material layer and the kraft material layer by an adhesive, such as a flame-resistant adhesive. Any suitable polypropylene layer can be utilized. For instance, in certain embodiments, the polypropylene layer is a white film that is from about 0.0010 to about 0.0020 inches thick. An example of an acceptable polypropylene vapor barrier layer is Lamtec Corporation's WMP-VR polypropylene/scrim/kraft facing material.

The inner layer 14 is positioned between the first outer layer 12 and the second outer layer 16. The inner layer 14 includes polyurethane foam 18. Suitable polyurethane foam can include resilient polyurethane foam as would be known in the art. Such polyurethane foams can include open-cell and closed-cell polyurethane foams, although open-cell foams are preferred. In certain embodiments, polyurethane foam can be a flame retardant variety of polyurethane foam.

In certain embodiments, the polyurethane foam is present in an amount of from about 80% to about 99% by weight of the inner layer 14, more particularly the polyurethane foam is present in an amount from about 90% by weight to about 99% by weight.

The inner layer 14 also includes adhesive 20. The adhesive can be a hot melt adhesive as would be known in the art. The adhesive 20 can coat portions of the polyurethane foam 18 and/or first outer layer 12 and/or second outer layer so as to form an adhesive layer 22. In this regard, adhesive layer 22 can serve to adhere the first outer layer 12 to a first side 24 of the inner layer 14 and the second outer layer 16 to a second side 26 of the inner layer 14.

In certain embodiments, the adhesive is present in an amount of less than about 10% by weight of the inner layer 14, more particularly the adhesive is present in an amount less than about 5% by weight.

The combined thickness of the first outer layer, second outer layer, and inner layer can be from about 0.10 to about 0.40 inches, more particularly the thickness can be from about 0.15 to about 0.30 inches, still more particularly the thickness can be from about 0.20 to about 0.30 inches.

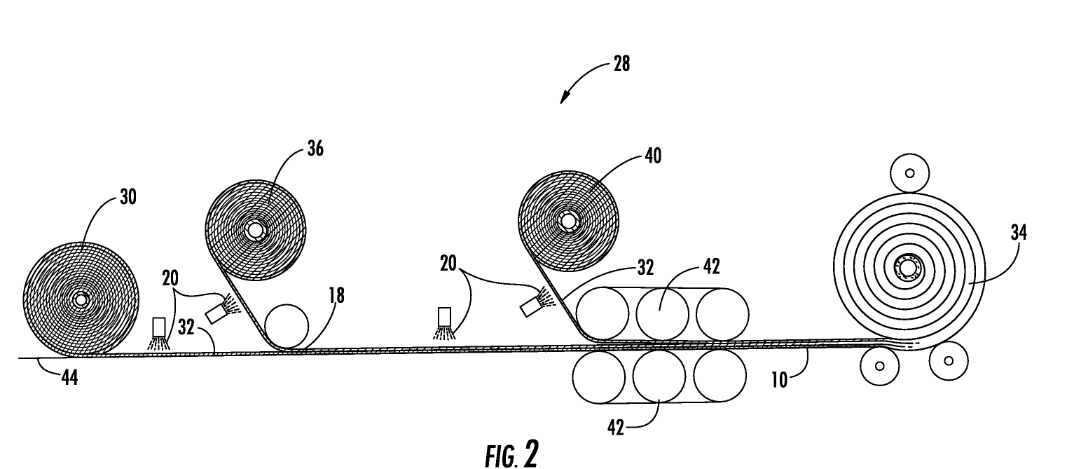

Referring to FIG. 2, certain embodiments of a method of making a reflective insulation product will now be described. Advantageously, the products of the present disclosure can be manufactured using hot spray lamination equipment that is already employed to make conventional products. However, the products of the present disclosure do not require the formaldehyde or fiberglass that are present in many conventional products. In addition, the products of the present disclosure can provide improved R-values and improved resilience when compared to conventional products.

An apparatus 28 for making the reflective insulation product 10 of the present disclosure is schematically depicted in FIG. 2. The apparatus 28 includes a first roll 30 of material for an outer layer 32. The apparatus 28 unrolls an outer layer 32 from the first roll 30 where it passes through various processing steps before being optionally rewound by a rewinding roll 34.

Polyurethane foam 18 is unrolled onto an outer layer 32 from second roll 36. Adhesive 20 can be applied to the polyurethane foam 18 as the polyurethane foam is being unrolled onto outer layer 32. The adhesive 20 can be misted, sprayed, or otherwise added to the polyurethane foam 18. Alternatively, or in addition to the adhesive added above, adhesive 20 can be coated on outer layer 32 prior to the application of polyurethane foam 18 to outer layer 32. In addition, other components can also be optionally added to polyurethane foam 18. For instance, if the polyurethane foam 18 is not flame retardant, a flame retardant composition as would be known in the art can be added to the polyurethane foam 18. The polyurethane foam 18 forms a substrate layer 38 on an outer layer 32 with the adhesive 20 potentially coating and/or permeating the substrate layer 38.

The apparatus 28 includes a third roll 40 of material for an outer layer 32. The apparatus 28 unrolls an outer layer 32 from the third roll 40 where it contacts the substrate layer 38 and enters a series of compression rollers 42 with the substrate layer 38 and outer layer 32. Again, either separately, or in addition to the adhesive added above, adhesive 20 can be coated on outer layer 32 prior to the application of outer layer 32 onto substrate layer 38. The substrate layer 38 is compressed between the outer layers 32 to form the reflective insulation product 10. The outer layers 32 can each adhere to respective sides of the substrate layer 38 by the adhesive 20.

The reflective insulation 10 can be moved over supporting rollers 44 for further processing. For instance, the reflective insulation can subjected to a perforating roller. The perforating roller can include a plurality of spikes along its axial length in the exemplary embodiment. As the reflective insulation 10 moves past the perforating roller the spikes that extend from the perforating roller can perforate an outer layer to form perforations in an outer layer. Such perforations can allow air trapped between the outer layers to escape from the reflective insulation 10 as it is rolled onto a reflective insulation roll.

The reflective insulation product described herein can be utilized to form a variety of different insulation products. For instance, in certain embodiments, the product can be utilized for batts, blankets, or other insulation products as would be known in the art.

The reflective insulation product 10 of the present disclosure can be installed in a roof of a building. In certain embodiments, the reflective insulation 10 is installed on the purlins by orienting a roll of reflective insulation perpendicular to the purlins and unrolling the reflective insulation across the purlins. The reflective insulation is allowed to sag between the purlins, such that there is a gap between the roof panels and the reflective insulation 10. The reflective insulation is held in place by the roof panels when they are secured to the purlins.

In certain embodiments, the edges of the reflective insulation product 10 are secured to purlins. The edges of the reflective insulation product 10 can be secured to the purlins by being sandwiched between a roof panel and the purlins, or they may be secured to the purlins by double-sided tape. The reflective insulation product 10 sags between the purlins, creating a space between the reflective insulation product 10 and the roof panel.

When the roof panel is warmer than an outer layer of the reflective insulation product 10, the roof panel radiates heat to the outer layer. If the outer layer is a reflective layer, the reflective layer reflects a large percentage of the radiated heat back to the roof panel.

When an interior surface of the building is warmer than an outer layer of the reflective insulation product, the interior surface radiates heat to the outer layer which can reflect at least a portion of the radiated heat back toward surfaces inside the building. The amount of heat radiated back toward surfaces inside the building varies depending on the type of outer layer that is used. For instance, a vapor barrier layer having an outer layer that is made from a reflective aluminum material can reflect more of radiated heat back towards the interior of a building than a vapor barrier having an outer surface that is white polypropylene.

In the interests of brevity and conciseness, any ranges of values set forth in this specification are to be construed as written description support for claims reciting any sub-ranges having endpoints which are whole number values within the specified range in question. By way of a hypothetical illustrative example, a disclosure in this specification of a range of 1-5 shall be considered to support claims to any of the following sub-ranges: 1-4; 1-3; 1-2; 2-5; 2-4; 2-3; 3-5; 3-4; and 4-5.

These and other modifications and variations to the present disclosure can be practiced by those of ordinary skill in the art, without departing from the spirit and scope of the present disclosure, which is more particularly set forth in the appended claims. In addition, it should be understood that aspects of the various embodiments can be interchanged both in whole or in part. Furthermore, those of ordinary skill in the art will appreciate that the foregoing description is by way of example only, and is not intended to limit the disclosure so further described in such appended claims.

What is claimed is:

1. A reflective insulation product comprising:
a first outer layer comprising reflective material;
a second outer layer; and
an inner layer comprising polyurethane foam and adhesive, the inner layer being positioned between the first outer layer and second outer layer such that the first outer layer is adhered to a first side of the inner layer by adhesive and the second outer layer is adhered to a second side of the inner layer by adhesive.

2. The reflective insulation product of claim 1, wherein the reflective material of the first layer comprises aluminum.

3. The reflective insulation product of claim 1, wherein the second outer layer comprises white polypropylene.

4. The reflective insulation product of claim 3, wherein the second outer layer comprises scrim material.

5. The reflective insulation product of claim 1, wherein the second outer layer comprises aluminum.

6. The reflective insulation product of claim 1, wherein the second outer layer is a laminate comprising a layer of polypropylene, a layer of scrim material, and a layer of kraft material.

7. The reflective insulation product of claim 1, wherein the first outer layer, second outer layer, and inner layer have a combined thickness of from about 0.15 to about 0.30 inches.

8. The reflective insulation product of claim 1, wherein the inner layer comprises from about 80% to about 99% by weight polyurethane foam.

9. The reflective insulation product of claim 1, wherein the adhesive comprises a hot melt adhesive.

10. A reflective insulation product comprising:
a first outer layer comprising reflective material;
a second outer layer; and
an inner layer comprising polyurethane foam and adhesive, the inner layer being positioned between the first outer layer and second outer layer such that the first outer layer is adhered to a first side of the inner layer by adhesive and the second outer layer is adhered to a second side of the inner layer by adhesive, the first outer layer, second outer layer, and inner layer having a combined thickness of from about 0.15 to about 0.30 inches.

11. The reflective insulation product of claim 10, wherein the reflective material of the first layer comprises aluminum.

12. The reflective insulation product of claim 10, wherein the second outer layer comprises white polypropylene.

13. The reflective insulation product of claim 12, wherein the second outer layer comprises scrim material.

14. The reflective insulation product of claim 10, wherein the second outer layer comprises aluminum.

15. The reflective insulation product of claim 10, wherein the second outer layer is a laminate comprising a layer of polypropylene, a layer of scrim material, and a layer of kraft material.

16. The reflective insulation product of claim 10, wherein the first outer layer, second outer layer, and inner layer have a combined thickness of from about 0.20 to about 0.30 inches.

17. A method of making a reflective insulation product comprising:
unrolling a length of polyurethane foam insulation;
applying adhesive on the polyurethane foam insulation, a first outer layer, a second outer layer, or combinations thereof;
contacting the length of polyurethane foam insulation with the first outer layer, the first outer layer comprising reflective material;
contacting the length of polyurethane foam insulation with the second outer layer;
compressing the polyurethane foam insulation between the first outer layer and second outer layer, the polyurethane foam insulation being positioned between the first outer layer and second outer layer to form an inner layer; and
allowing the first outer layer to adhere to a first side of the inner layer by the adhesive and the second outer layer to adhere to a second side of the inner layer by the adhesive.

18. A method as in claim 17, wherein the second outer layer comprises white polypropylene.

19. A method as in claim 17, wherein the second outer layer comprises aluminum.

20. A method as in claim 17, wherein the second outer layer comprises scrim material.
